(19) United States
(12) Patent Application Publication
(10) Pub. No.: US 2006/0272171 A1
(43) Pub. Date: Dec. 7, 2006

(54) De-misting system for multi-pane glazing

(76) Inventor: David Ferracuti, Mississauga (CA)

Correspondence Address: D. W. EGGINS, 18 DOWNSVIEW DRIVE, BARRIE, ON, L4M 4P8, CA

(21) Appl. No.: 11/146,056

(22) Filed: Jun. 7, 2005

(51) Int. Cl. F26B 3/00

(52) U.S. Cl. 34/329; 34/472

(57) ABSTRACT

Misted/fogged Thermopane (T.M.) windows have dry air, which may be heated, pumped through the window cavity, to remove the moisture, and to fill it with dry air, followed by insertion of porous plugs that permit the outward transfer of moisture from the cavity, while resisting any reversed moisture transfer into the cavity by way of a hydrophobic plug end portion that encloses the cavity aperture. The drying apparatus receives compressed air, passes it through a dryer, filters the air, reduces the pressure to a safe value, and passes the air (which may be heated) to an air gun equipped with a nozzle hose, for passage as a purging medium within the window cavity by way of ventilation access holes that are drilled at the bottom and the top of the window.

### CROSS REFERENCE TO RELATED APPLICATIONS

Not Applicable (N/A)

### STATEMENT REGARDING FEDERALLY SPONSORED RESEARCH OR DEVELOPMENT

(N/A)

### REFERENCE TO MICROFICHE APPENDIX

(N/A)

### BACKGROUND OF THE INVENTION

This invention is directed to a system for removing moisture and water vapour from the interior cavity or cavities of multi-pane glazing units, and includes provisions to maintain such de-misted cavities in an ongoing, substantially de-misted condition.

2. Multi-pane glazing units usually consist of an inner and an outer pane, generally of glass, having a hermetic seal about the periphery, and frequently containing rare gases such as argon, to minimize thermal transfer through the unit. Owing to imperfections of such peripheral seals, and for other possible causes, moisture penetrates into the interior cavity of the glazing unit, to form a mist over its inner surfaces, and mar its appearance. Also, such moisture contamination has been found to reduce the insulative R value of the unit by as much as 80%. One prior system that attempts to deal with the problem involves accessing the interior cavity, spraying a de-moisturizing agent within the cavity, and sealing the access aperture by way of a simple flap valve that is intended to permit ready egress of gases from the unit cavity, while preventing the ingress of outside air to the cavity. This prior system is ineffective, both in its initial de-misting, and in the effectiveness of the flap valve provision.

### BRIEF SUMMARY OF THE INVENTION

In accordance with the present invention there is provided a system having an apparatus for pumping dry air at a controlled flow rate into and through a selected window cavity, to dry-out and purge that cavity of any moisture present, and to fill it with de-moisturized air, followed by the application of sealing means to re-seal the window cavity. In a preferred embodiment, the air is pre-dried, and may be heated to optimize the rate of moisture removal; and the sealing means consists of a plug of controlled permeability, permitting the up-take and outward transfer of moisture from the cavity, while resisting any reversed moisture transfer into the cavity. This plug may include a water-attracting hydrophilic portion that is positioned within the window cavity, and a hydrophobic end portion that encloses the cavity aperture, to resist the ingress of moisture to the cavity.

The hydrophilic portion of the plug may be blended with particles of dessicant material, such as silica jel, to enhance water up-take.

The ‘plug valves’ can consist of plastic porous resins (e.g. Polymers). The alternatives of ceramics, and fibers that transfer moisture through capillary action and forces of adhesion, cohesion, and surface tension are contemplated. Material selection is based upon providing an effective performance, where porosity, costs, aesthetics and enviromental consideration come into play.

The air displacement apparatus receives air from a compressor, passes the compressed air through a dryer, to reduce the amount of moisture that may be present, filters the air, and reduces the pressure to a predetermined lower range of pressures.

The air may be heated to a predetermined temperature, in accordance with the ambient conditions, and the characteristics of the window. Safe operating temperatures lie in the range of 20 to 40 degrees Celsius, and temperature and air flow rate selection are predicated upon window size and the thickness of the glass.

Larger window size and the use of thinner glass both adversely affect the permissible value of selected air temperature and the rate of air admission.

The dried, filtered, pressure-controlled air, preferably in a heated condition for enhanced drying rates, passes to an air gun equipped with a nozzle hose, for passage as a purging medium within the cavity of a multi-pane glazing unit.

Ventilation access holes are drilled at the bottom and the top of the subject glazing unit, preferably in mutual diagonal relation, so that the purging medium can flow upwardly throughout the unit cavity, vapourizing and entraining moisture that is present, and removing it from the cavity.

On completion of a purging operation the ventilation access holes are each plugged with a sealing plug, as described above.

The access holes may be drilled from the interior of the window, or from the exterior, and may traverse the window, or be limited to penetration of the window cavity.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a schematic general view of a glazing unit having ventilation access holes;

FIG. 2 is a side elevation of an embodiment of a vapour-purging apparatus in accordance with the present invention; and,

FIGS. 3 and 4 are sectioned side views of two embodiments of window cavity sealing plugs in accordance with the present invention.

### DETAILED DESCRIPTION OF THE INVENTION

It will be understood by those skilled in the art that the above disclosure is directed primarily to specific embodiments of the present invention, and that the subject invention is susceptible of reduction to practice in other embodiments that fall within the scope of the appended claims.

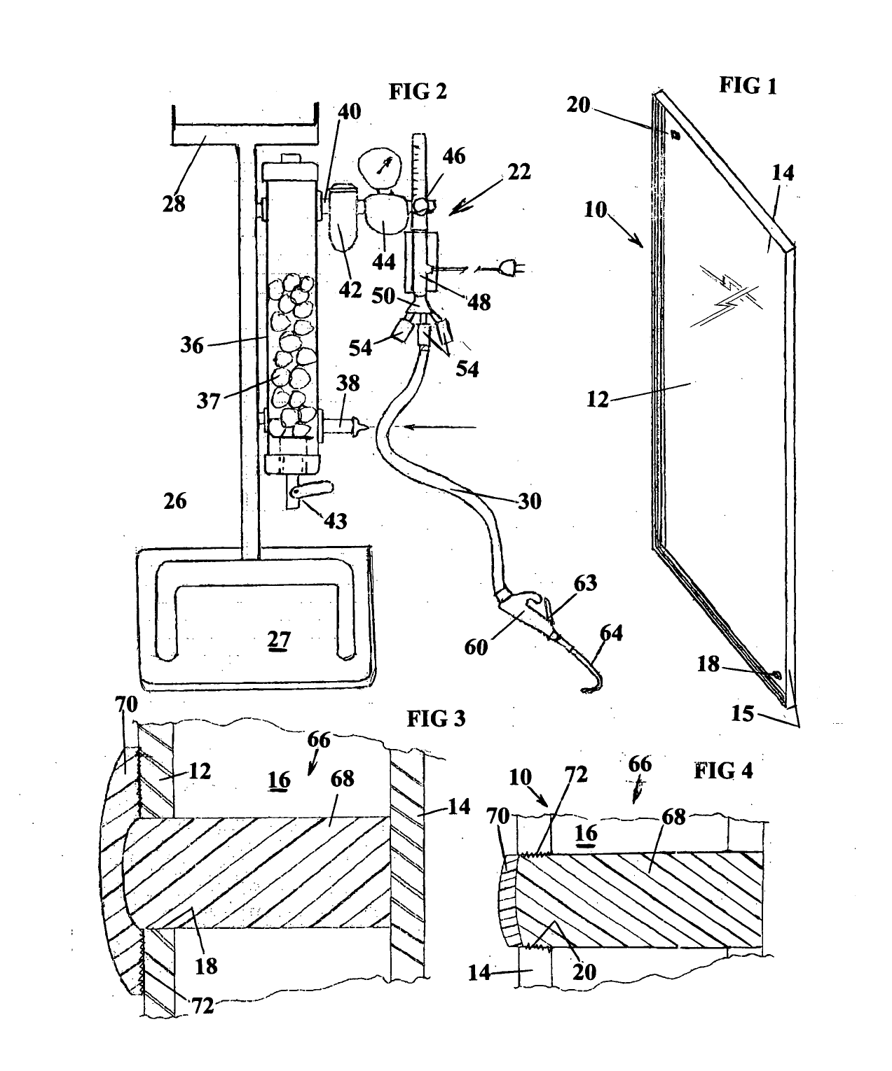

Referring to FIG. 1, a glazing unit 10 comprising a thermopane (T.M.) window has an inner glazing sheet 12 and an outer glazing sheet 14, the periphery of which sheets are sealed in spaced relation by an initially hermetic peripheral seal 15.

The unit 10, as is well known, is installed with supporting hardware (not shown), as part of a wall of a building.

For purposes of the present invention the unit 10 is presumed to have suffered failure of the hermetic seal 15, with consequent inward leakage of moisture into the unit inner cavity 16, which results in misting of one or both of the inner glazing surfaces of unit 10.

Access to the cavity 16, as a preliminary step of the present process is attained by the drilling of access bores 18, 20, respectively located at the bottom and top of the inner glazing sheet 12. Typically, the bores 18, 20 are in the order of three to four millimeters diameter (i.e. about 0.12 to 0.16 inches diameter).

Turning to FIG. 2, the air displacement apparatus 22 has a tubular support stand 26 supported on a base member 27. The support stand 26 has a transversely extending hose rack 28 on which service hoses 30 are stored and transported.

A cylindrical air dryer 36 is mounted vertically on the stand 26, having an air inlet 38 and air outlet 40. The dryer 36 is charged with silica gel dessicant 37, through which air travels upwardly. A lower drain valve 43 permits downward drainage of accumulated water from the dryer 36. The air outlet 40 connects to an air filter 42, the outlet of which connects with a pressure regulating valve 44, a flow valve 46 and an air heater 48, all connected in series relation. The heater 48 has a heat shield thereabout.

The outlet of the heater 48 connects with a manifold 50, having a number of quick-disconnect couplers 54, to which small diameter air hoses 30 (of which only one is illustrated) are connected. Each air hose 30 serves a respective air gun 60, having a control lever 63. The gun 60 is fitted with a small diameter outlet hose 64 that is sized to fit the access bore 18 in the glazing sheet 12.

Turning to FIGS. 3 and 4, the window unit of FIG. 3 is drilled from the inside, having only the inner sheet 12 drilled; while the unit 10 of FIG. 4 is drilled from the outside, having the outer sheet 14 and the inner sheet 12 both drilled.

The sealing plugs 66 have a cylindrical body portion 68 consisting of a high porosity plastic compound of hydrophilic polyurethane, possibly blended with a dessicant, and an outer end portion 70 of high porosity hydrophobic polyurethane.

The outer end portion 70 may have an adhesive surface coating 72 at its interface with the glazing sheet 12.

The sealing plugs 66 are sized diametrically to provide a tight push fit with the access bores 18, 20.

In use, to treat a defective glazing unit 10 that has evidenced water vapour fogging of its inner surface or surfaces or droplet formation, access bores 18, 20 are drilled near the bottom and top edges of the accessible inner glazing sheet 12 of unit 10. The glazing sheets may be of glass or plastic.

An air displacement apparatus 22 is coupled at air inlet 38 by hose to a compressed air supply (not shown), operating at standard supply pressure in the range 100 to 125 psi. The admitted air flows through the air dryer 36, passes through the air filter 42 to the pressure regulator 44 and flow valve 46, where the pressure is dropped to a value of 5-10 psi (gauge).

In the heater 48 the temperature of the air may be raised a desired amount, to promote drying rates. This temperature selection may be influenced by the length of the air hoses 58 and the ambient temperature to which the window outer glazing sheet 14 is subject, so as to avoid thermal shock to the unit 10, with consequent damage.

The several outlet couplers 54 of the manifold 50 permits the apparatus to service a corresponding number of adjacent windows simultaneously.

1. A cavity de-watering apparatus, comprising a pressure vessel to receive compressed air at a first, delivery pressure; filter means connected to the pressure vessel to receive air therefrom, in filtering relation therewith; pressure control means to reduce the pressure of air passing therethrough to a predetermined second, utilization pressure; and delivery means, in use to deliver air at reduced pressure to said cavity, for passage therethrough, to entrain water and water vapour contained within said cavity, for removal from the cavity.

2. The apparatus as set forth in claim 1, wherein said pressure vessel serves to dewater said compressed air on passage therethrough.

3. The apparatus as set forth in claim 2, wherein said pressure vessel contains an air permeable dewatering substance.

4. The apparatus as set forth in claim 3, wherein said dewatering substance is a dessicant material.

5. The apparatus as set forth in claim 4, wherein said dessicant material is silica jel.

6. The apparatus as set forth in claim 2, wherein said pressure vessel includes a drainage valve, to permit selective drainage of liquid from said vessel.

7. The apparatus as set forth in claim 1, including heater means to raise the temperature of said air, said delivery means including a flexible hose connected with said heater means, and flow control means to control the passage of air through said delivery means.

8. The apparatus as set forth in claim 7, said flow control means consisting of an air gun having a control lever in flow-controlling relation therewith, and an outlet hose of predetermined limited diameter, insertable within an access aperture connecting to said cavity.

9. The apparatus as set forth in claim 8, in combination with sealing plug means insertable in substantially sealing relation with said access aperture.

10. The combination as set forth in claim 9, wherein said plug means includes a cylindrical hydrophilic inner portion for insertion within said cavity, and a hydrophobic outer portion to substantially seal said cavity against ready moisture transfer therethrough.

11. The combination as set forth in claim 10, wherein said plug means is of high porosity plastic, to enable the transfer of water therethrough.

12. The combination as set forth in claim 10, wherein said hydrophobic portion includes a dessicant material in blended relation with a high porosity plastic.

13. The method of de-fogging a multi pane window having at least one cavity located between substantially mutually parallel glazing panes, comprising the steps: forming at least one access aperture through a said glazing pane; passing compressed gas at a predetermined flow rate into the cavity, to disperse with the gas fluid contents located within the cavity; discharging from the cavity the gas together with the dispersed fluid contents of the cavity, to substantially dry-out the cavity, and substantially sealing said aperture against the ingress of atmospheric moisture into the cavity.

14. The method as set forth in claim 13, wherein at least two said access apertures to said cavity are formed, being in mutually spaced relation to promote passage of said gas through the cavity.

15. The method as set forth in claim 14, including drying said compressed gas prior to passing said gas into said cavity

16. The method as set forth in claim 13, including the step of heating said compressed gas prior to passing the gas into said cavity, to enhance the uptake of moisture by the gas within the cavity.

17. The method as set forth in claim 15, including filtering said compressed gas prior to passage thereof to said cavity.

18. The method as set forth in claim 13, including regulating the pressure of said compressed gas to provide a limited flow rate into said cavity.

19. The method as set forth in claim 13, wherein said gas is air.

20. The method of de-fogging a dual pane window having a cavity located between two substantially mutually parallel glass panes, comprising the steps: forming a first small access aperture through an accessible said glass pane, adjacent its lower edge; forming a second small access aperture through said accessible glass pane, adjacent its upper edge; passing compressed air through a drying means, to at least partially dry the air; passing the dried air through a filter, to remove particulate foreign matter; reducing the pressure of said filtered air to a predetermined value; passing said reduced pressure air to heating means to raise the temperature of the air; passing the heated air into said cavity, by way of said first aperture to heat the cavity together with fluid contents located within the cavity; discharging the heated fluid contents from the cavity, by way of said second aperture to substantially dry-out the cavity, and substantially sealing said apertures against the ingress of atmospheric moisture into the cavity.
